(19) United States
(12) Patent Application Publication
(10) Pub. No.: US 2012/0137970 A1
(43) Pub. Date: Jun. 7, 2012

(54) SURFACE TREATMENT DEVICE FOR CYLINDER BARREL

(75) Inventors: Hiroyuki Naruse, Tochigi (JP); Hitoshi Karasawa, Tochigi (JP); Kenichi Yokoo, Tochigi (JP)

(73) Assignee: HONDA MOTOR CO., LTD., MINATO-KU, TOKYO (JP)

(21) Appl. No.: 13/389,846

(22) PCT Filed: Jul. 1, 2010
(86) PCT No.: PCT/JP2010/061242

§ 371 Date: Feb. 10, 2012

(30) Foreign Application Priority Data
Sep. 1, 2009 (JP) 2009-201754

(51) Int. Cl. B05C 13/02

(52) U.S. Cl. 118/500

(57) ABSTRACT

Provided is a device for treating the inner surface of a cylinder barrel. A cover member (32) is provided, at the lower surface (59) thereof, with seal rings (54, 55, 56). The seal rings (54, 55, 56) are disposed concentrically about the center axis (63) of a cylinder barrel (43, 67). The lower ends of the seal rings (54, 55, 56) are disposed at different levels of height in such a manner that the farther away from the center axis (63), the higher the positions of the lower ends relative to the seal ring (54) closest to the center axis (63).

### TECHNICAL FIELD

The present invention relates to a technique for treating an inner surface of a cylinder barrel, provided on a cylinder block, by bringing a treatment solution into contact with the inner surface of the cylinder barrel.

### BACKGROUND ART

Inner surfaces of cylinder barrels of an engine are exposed to friction produced by the piston rings and to high heat produced by fuel combustion, and for this reason these surfaces must be durable. Surface treatments are effective in enhancing durability of surfaces. When carrying out a plating treatment, which is one common surface treatment, it is desirable to eliminate soiling and the like on the surface prior to the plating treatment. Such treatments for eliminating soiling and the like on the surface prior to surface treatment are called pretreatments. One example of a pretreatment for a plating treatment is described with reference to FIG. 11 hereof.

As shown in FIG. 11, the pretreatment involves carrying out an etching treatment, an acid activation treatment, a first zinc substitution process, a dissolution activation process, and a second zinc substitution process. Even in the case of etching treatment alone, treatment is composed of multiple steps such as chemical treatment with treatment solution, a primary rinse and a secondary rinse for cleaning purposes, and an idler or the like to prevent drying out. Of these processes, specific examples of chemical treatment steps have been proposed to date (see Patent Literature 1).

FIG. 12 shows a surface treatment device disclosed in Patent Literature 1.

Referring now to FIG. 12, a cylinder block 101 rests on a pallet 104 which is provided with a lower opening obstruction member 103, obstructing the lower opening of the cylinder block 101. The pallet 104 is then disposed on a pan 105. A cover member 107 provided with a nozzle 106 is moved in the direction indicated by arrow (1) to obstruct the upper opening of the cylinder block 101, with sealing provided by a flexible seal ring 102.

As shown by arrow (2), a treatment solution is supplied to the nozzle 106 from a treatment solution supply channel 108. As shown by arrow (3), the supplied treatment solution is sprayed to the bottom of the cylinder barrel 110 from a treatment solution spray opening 109, and as shown by arrow (4), ascends while contacting the inner surface of the cylinder barrel 110. As shown by arrow (5), the treatment solution inside the cylinder barrel 110 is discharged primarily through a first drainage passage 111 which is provided to the pallet 104; while as shown by arrow (6), the remaining portion of the treatment solution is discharged through a second drainage passage 112 which is provided to a lid 107.

On production lines, there are instances in which cylinder barrels of various diameters undergo pretreatment on one line. In order to carry out pretreatment of cylinder barrels of different diameters, the upper opening of each of the respective cylinder barrels must be sealed with a seal ring corresponding to the diameter of the cylinder barrel.

For a large diameter cylinder barrel, a cover member 107 provided with a large diameter seal ring 102 is prepared, whereas for a small diameter cylinder barrel, a cover member 107 provided with a small diameter seal ring 102 is prepared. In this way, a concern in the prior art was the need to prepare large numbers of cover members 107 corresponding to different cylinder barrel diameters. This necessitated increased procurement costs and storage costs for the cover members 107. Additionally, there was an increase in exchange steps for exchanging the cover members 107. Recent demand for reduced costs has led to a need for improvement.

### PRIOR ART LITERATURE

### Patent Literature

Patent Literature 1: Japanese Patent Application Laid-Open Publication No. 2008-214730

### SUMMARY OF INVENTION

### Technical Problem

It is therefore an object of the present invention to provide a surface treatment device for cylinder barrels, which affords reduced costs.

### Solution to Problem

According to an aspect of the present invention, there is provided a cylinder barrel surface treatment device for supplying a treatment solution into a cylinder barrel of a cylinder block of an internal combustion engine and treating an inner surface of the cylinder barrel, which device comprises: a cylinder block supported on a pallet such that a gasket face is oriented upwardly; and a cover member laid on the gasket face in such a manner as to cover an upper opening of the cylinder barrel, wherein the cover member is provided at a lower face thereof with a plurality of sealing rings for making intimate contact with the gasket face so as to prevent leakage of the treatment solution, and the sealing rings have flexibility, are disposed concentrically centered on a center axis of the cylinder barrel, and are imparted with a height differential such that levels of lower edges of the sealing rings progressively increase in height further away from the center axis relative to the sealing ring closest to the center axis.

Preferably, the lower face of the cover member is given a stepped shape such that the sealing rings project by substantially the same margin from the lower face.

Desirably, the pallet comprises a plurality of pallets for supporting each of the cylinder blocks, which are of different size.

In a preferred form, the lower face of the cover member is a flat face, and the plurality of sealing rings is provided to the lower face of the flat face.

### Advantageous Effects of Invention

For a small diameter cylinder barrel, the seal ring lying towards the center axis among the plurality of seal rings is placed against the gasket face. For a cylinder barrel of larger diameter, the neighboring seal ring is placed against the gasket face. For a cylinder barrel of even larger diameter, the next neighboring seal ring is placed against the gasket face. In this manner, sealing is created by seal rings appropriate for the diameter of the cylinder barrel. Because there is no need to swap out the seal ring and the cover member even for cylinder barrels of different diameters, a reduction in the number of swap out procedures can be attained. Additionally, because the cover member is universal, there are fewer parts, and the overall cost of the device can be reduced.

Projection margin is equivalent to collapse margin, and this collapse margin impacts the sealing properties. If the projection margin should happen to be irregular, it is possible that deviations in sealing will be observed, and design of the shape of the seal ring will be difficult. With respect to this point, according to the present invention, because projection margins are substantially the same, design of the seal ring shape is easy, and it is possible to reduce the procurement costs of the seal rings.

### BRIEF DESCRIPTION OF DRAWINGS

FIG. 1 is a side elevational view illustrating a cylinder barrel surface treatment device according to the present invention;

FIG. 2 is a sectional view illustrating a surface treatment section of FIG. 1;

FIG. 3 illustrate in cross-section upper openings of cylinder barrels of different size in sealed condition;

FIG. 4 is a view showing two cylinder barrels of different size in simultaneously sealed condition;

FIG. 5 is a sectional view showing a comparison between a cover member with a lower face being flat and the present embodiment in which the face has a stepped pattern;

FIG. 6 is an enlarged view of region 6 of FIG. 5;

FIG. 7 is a view illustrating a modification of the embodiment shown in FIG. 6;

FIG. 8 is a view showing an embodiment similar to but separate from the embodiment of FIG. 4;

FIG. 9 is an enlarged cross-sectional view taken along line 9-9 of FIG. 1;

FIG. 10 is a view illustrating an operation of a cylinder barrel surface treatment device according to the embodiment of FIG. 8;

FIG. 11 is a view showing pretreatment steps of conventional plating; and

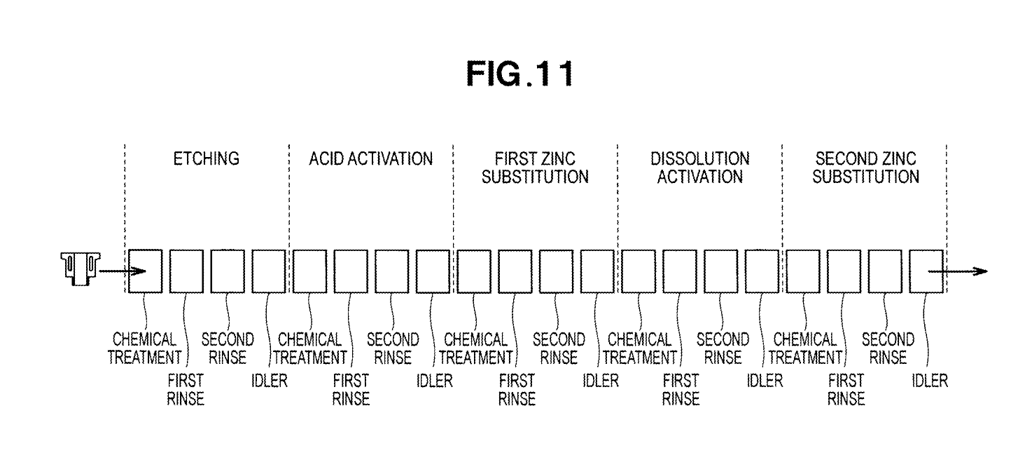

FIG. 12 is a schematic view illustrating a conventional cylinder barrel surface treatment device.

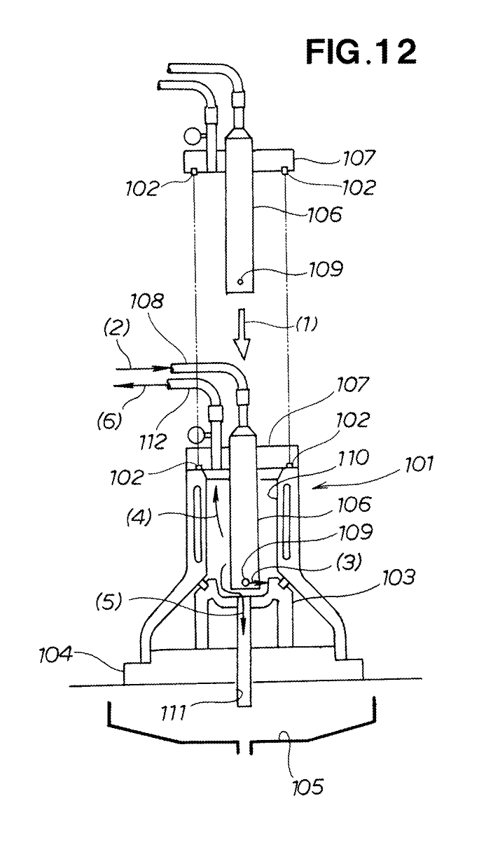

### DESCRIPTION OF EMBODIMENT

A preferred embodiment of the present invention will now be described with reference to the accompanying drawings.

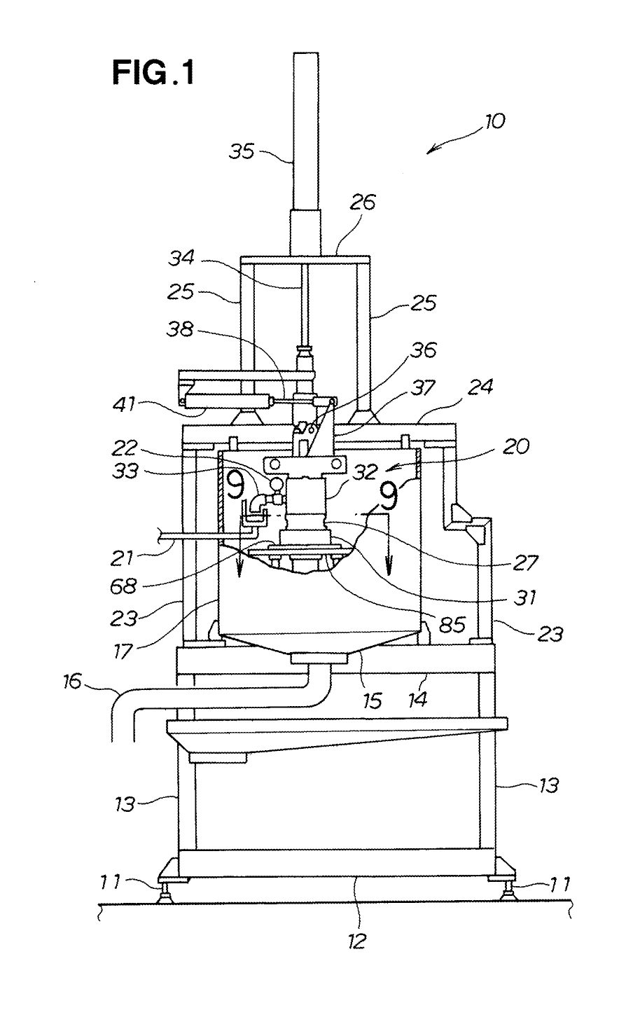

As shown in FIG. 1, the cylinder barrel surface treatment device 10 according to the present embodiment is provided with a base 12 having an adjuster 11; a lower section post 13 which rises from this base 12; an intermediate section support member 14 provided at the upper end of this lower section post 13; a pan 15 supported by this intermediate section support member 14 and used for collecting treatment solution; a treatment solution drain pipe 16 for draining to the outside treatment solution which has collected in this pan 15; an enclosing member 17 provided above the pan 15; a surface treatment section 20 provided to the intermediate section support member 14 in a manner enclosed by this enclosing member 17; a drain pipe 21 provided to this surface treatment section 20 for directing drain fluid from the upper section of the surface treatment section 20; a treatment solution detection section 22 for monitoring drain fluid in this drain pipe 21; an intermediate section post 23 which rises from the intermediate section support member 14; an upper section support member 24 provided at the upper end of this intermediate section post 23; an upper section post 25 which rises from this upper section support member 24; and a top panel 26 provided at the upper end of this upper section post 25.

As will be discussed in detail later, the surface treatment section 20 is provided with a pallet 31 for supporting a cylinder block 27 that is undergoing surface treatment, a cover member 32 for covering the upper section of the cylinder block 27, and a second drain passage 33 provided to the cover member 32 and used to discharge a portion of the treatment solution.

The surface treatment device 10 for the cylinder barrel inner surface is provided with a lifting/lowering cylinder 35 for alternately lifting and lowering the cover member 32 via a lifting/lowering rod 34 provided to the top panel 26; a swivel section 37 swivelably centered about a rotating shaft 36 at the lower end of the lifting/lowering rod 34; and a swivel cylinder 41 provided at the lower end of the lifting/lowering rod 34, for swiveling the swivel section 37 via an extending/retracting rod 38.

The description turns next to the surface treatment section 20.

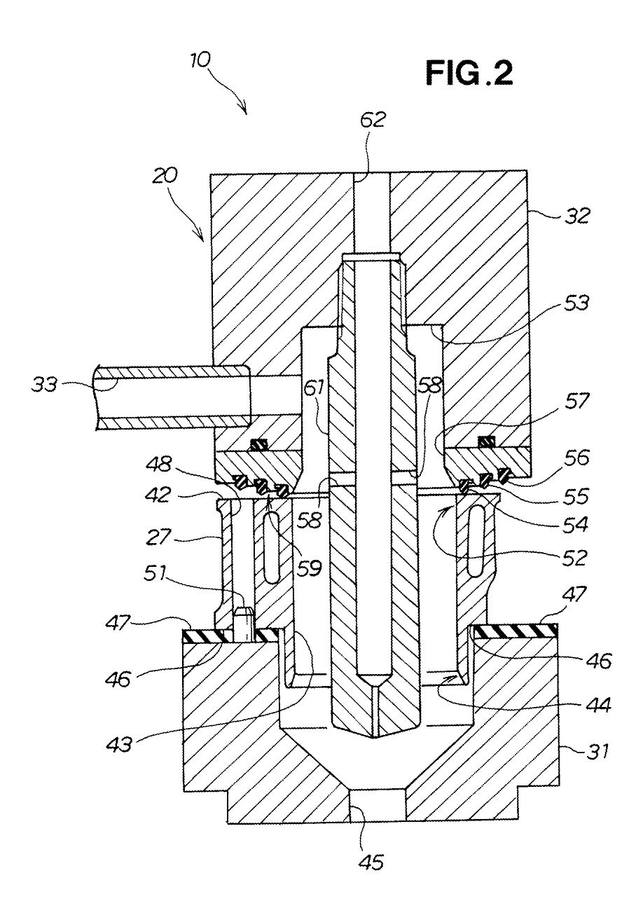

As shown in FIG. 2, the surface treatment section 20 is composed of a pallet 31 adapted to support the cylinder block 27 such that a gasket face 42 of the cylinder block 27 is at the top, as well as to obstruct a lower opening 44 of a cylinder barrel 43; a first drain passage 45 provided to this pallet 31, for discharging a portion of treatment solution which has accumulated inside the cylinder barrel 43; a shoulder section seal member 47 provided to the pallet 31, for sealing a shoulder section 46 of the cylinder block 27; a positioning pin 51 provided to the pallet 31, for positioning of a hole 48 of the cylinder block 27; the cover member 32 which has a recess section 53 communicating with an upper opening 52 of the cylinder barrel 43, and which rests on the gasket face 42 to cover the upper opening 52 of the cylinder barrel 43; flexible first to third seal rings 54, 55, 56 provided to a lower face 59 of this cover member 32 and adapted to seal the gasket face 42; a nozzle 61 which is mounted on the cover member 32 so as to slip downward into the cover member 32 from above, which has a treatment solution spray opening 58 for spraying a treatment solution towards a wall 57 of the recess section 53, and which supplies the treatment solution across the wall 57 of the recess section 53 and to the inner surface of the cylinder barrel 43; a treatment solution supply channel 62 for supplying the treatment solution to this nozzle 61; and the second drain passage 33 provided to the cover member 32, for discharging the remainder of the treatment solution which has accumulated in the cylinder barrel 43.

The treatment solution spray opening 58 which is formed in the nozzle 61 is situated above the upper opening 52 of the cylinder block 27. Therefore, the treatment solution flows uniformly from the upper edge to the lower edge of the inner surface of the cylinder barrel 43. The treatment solution spray opening 58 is composed of a plurality of openings which is preferably arrayed in a radial pattern in the diametrical direction of the nozzle 61, but which may be arrayed in cross shaped pattern instead.

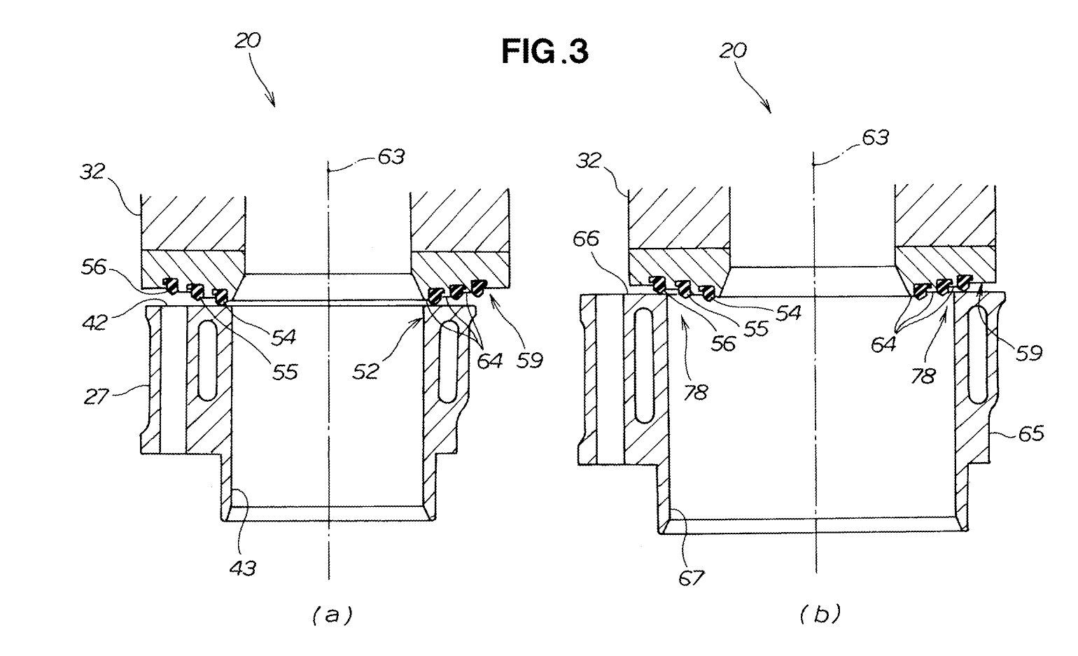

Next, conditions for sealing gasket faces 42, 66 of cylinder blocks 27, 65 of different size are described on the basis of FIG. 3(a) and (b).

As shown in FIG. 3(a), the cylinder block 27 provided with the cylinder barrel 43 of small inside diameter is positioned with the gasket face 42 at the top. The cover member 32 is provided on the lower face 59 thereof with a first seal ring 54, a second seal ring 55, and a third seal ring 56 which are flexible and adapted for intimate contact against the gasket face 42 to prevent leakage of the treatment solution, the rings being provided in a concentric pattern in the diametrical direction centered about the center axis 63 of the cylinder barrel. These first to third seal rings 54, 55, 56 are mounted at a height differential such that the levels of the lower edges of the second sealing ring 55 and the third sealing ring 56 which are further away from the center axis 63 with respect to the first sealing ring 54 which is closest to the center axis 63 occupy progressively higher positions. The lower face 59 of the cover member 32 is provided with step sections 64 of stepped form, so that the downward projection margins of the first to third seal rings 54, 55, 56 are substantially the same. Only the first seal ring 54 provided in the highest step section 64 contacts the gasket face 42 and thereby forms a seal. The second and third seal rings 55, 56 do not contact the gasket face 42.

FIG. 3(b) depicts conditions for sealing the gasket face 66 of the cylinder block 65 provided with the cylinder barrel 67 having a large inside diameter; elements comparable to those in FIG. 3(a) are assigned like reference symbols, and are not discussed in detail.

Only the third seal ring 56 provided in the lowest step section 64 contacts the gasket face 66 and seals it. The diameters of the first and second seals rings 54, 55 are smaller than the inside diameter of the cylinder barrel 67. Therefore, the first and second seals rings 54, 55 lie inward from the inner surface of the cylinder barrel 67 and do not contact the cylinder barrel 67.

In this way, the different cylinder blocks 27, 65 can be sealed with the same cover member 32 and seal rings 53, 54, 55, and therefore on the production line there is no need to swap out the cover member 32, even when carrying out pretreatment of different types of cylinder blocks, and the number of steps can be reduced.

In the case of a cylinder barrel provided with an inside diameter of an intermediate size between the inside diameter of the cylinder barrel 43 and the inside diameter of the cylinder barrel 67, the second seal ring 55 contacts the gasket face and seals it, while the first and third seal rings 54, 56 do not contact the cylinder block. In this way, sealing is created by appropriate seal rings, according to the diameter of the cylinder barrel.

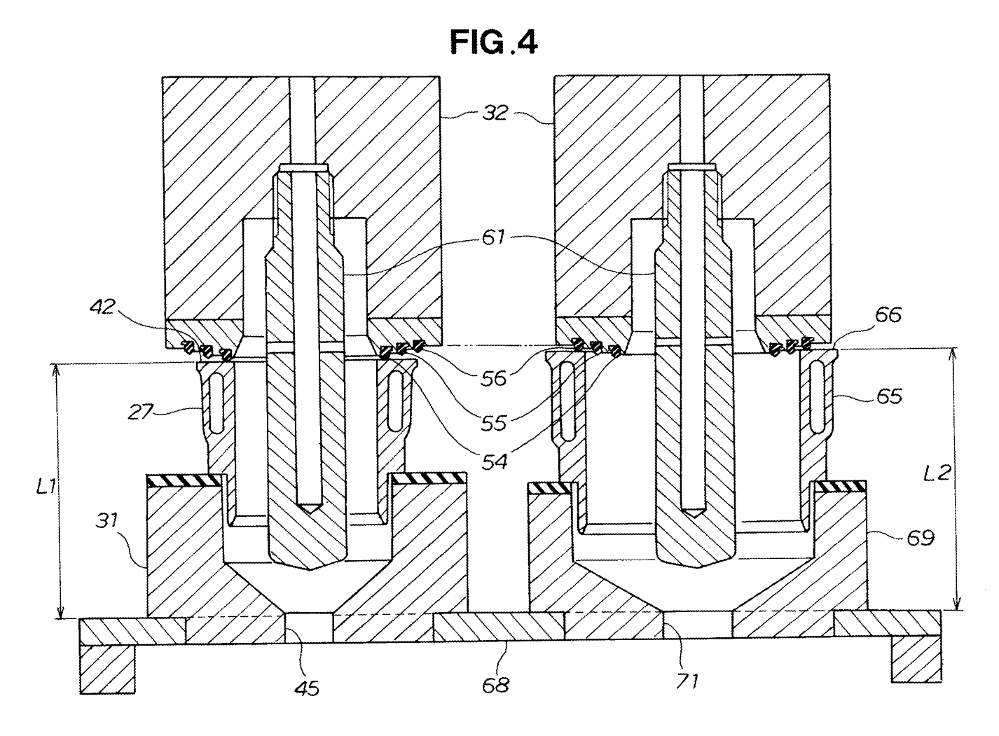

Next, conditions for simultaneous sealing of cylinder blocks 27, 65 of different size are described on the basis of FIG. 4.

As shown in FIG. 4, a master pallet 68 is provided with a first pallet 31 and a second pallet 69 as ancillary pallets. The small cylinder block 27 rests on the first pallet 31, and the large cylinder block 65 rests on the second pallet 69.

The height L1 from the upper face of the master pallet 68 to the gasket face 42 of the cylinder block 27 represents height to contact with the first seal ring 54 of the cover member 32. On the other hand, the height L2 from the upper face of the master pallet 68 to the gasket face 66 of the cylinder block 65 represents height to contact with the third seal ring 56 of the cover member 32. The cylinder blocks 27, 65 of different size can be sealed simultaneously, under conditions in which the two cover members 32 are at the same height. Because the cover members 32 and the nozzles 61 are both the same, there is no need to swap out the cover members 32, and the number of steps can be reduced. Furthermore, the flow rate of the discharged treatment solution can be adjusted by varying the diameter of the first drain passages 45, 71.

The description turns next to a comparison of a cover member lacking step sections, and the present embodiment, which has step sections 64.

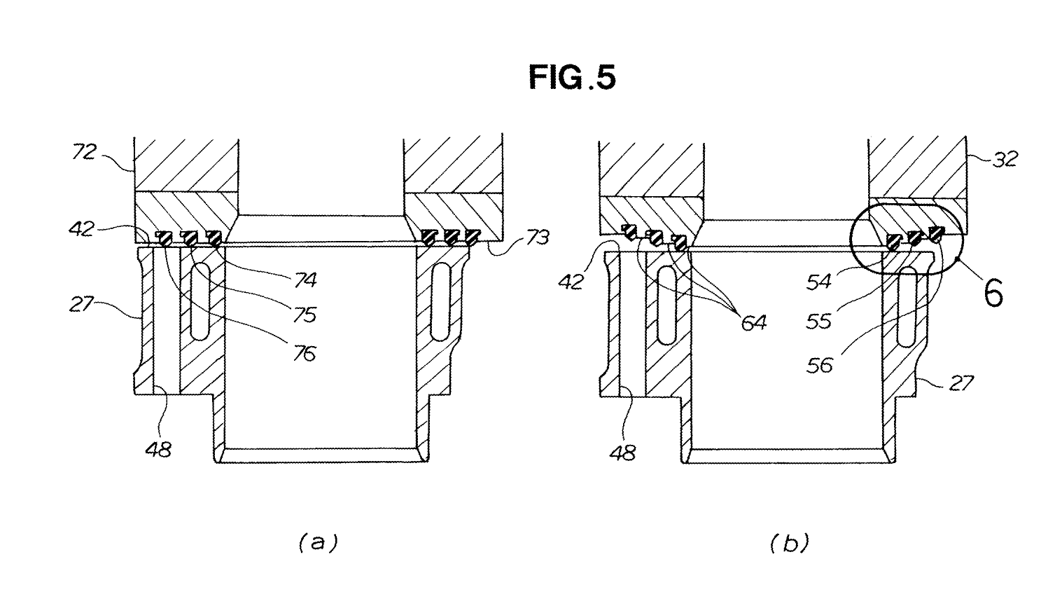

FIG. 5(a) depicts an example in which the lower face 73 of a cover member 72 is a flat face not provided with step sections. First, second, and third seal rings 74, 75, 76 each contact the gasket face 42. The third seal ring 76 is prone to breakage or deformation due to contact with the edge of the hole 48.

In the case where the small cylinder block 27 is to be sealed, the first to third seal rings 74, 75, 76 all contact the gasket face 66, but in the case where the large cylinder block (FIG. 3, reference symbol 65) is to be sealed, only the third seal ring 76 contacts the gasket face 66, and therefore a difference in seal pressure arises. In order to make the seal pressures equal, it is necessary to make the seal clamping force higher in the case where the first to third seal rings 74, 75, 76 are all in contact, as compared with the case where only the third seal ring 76 is in contact. In order to increase the seal clamping force, it is necessary for the lifting/lowering cylinder 35 (FIG. 1) to be larger, and the cost of the device will be higher.

On the other hand, in the embodiment of FIG. 5(b), whereas the first seal ring 54 contacts the gasket face 42, the second and third seal rings 55, 56 do not contact the gasket face, and therefore the second and third seal rings 55, 56 do not experience any damage. Moreover, despite the cylinder blocks being of different size, each is contacted by only one of the first to third seal rings 54, 55, 56, and therefore seal pressure can be made uniform. Because it is unnecessary to excessively increase the clamping force for sealing, a small scale lifting/lowering cylinder 35 suffices for this purpose, and the cost of the device can be reduced.

The discussion turns next to the cross sectional shape of the seal rings 54, 55, 56.

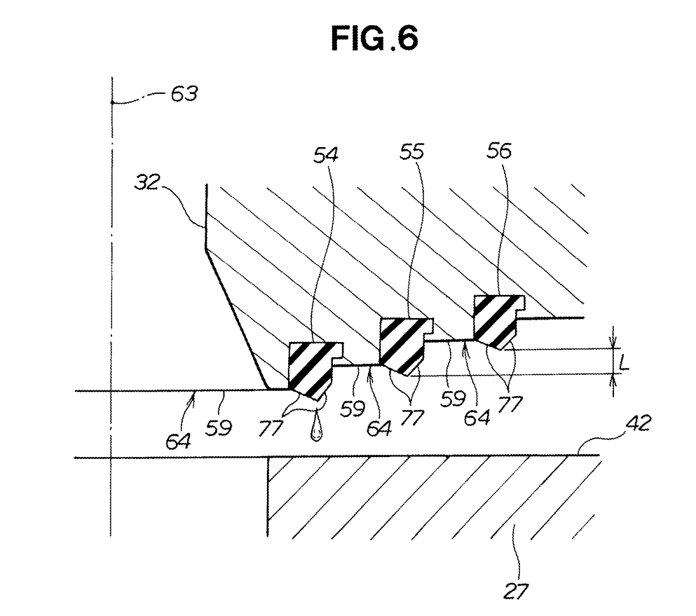

As shown in FIG. 6, a slope 77 is provided at the distal edge section of each of the first to third seal rings 54, 55, 56. The effect of doing so is that the treatment solution drips down readily and the first to third seal rings 54, 55, 56 do not stick to the gasket face 42.

The projection margins of the first to third seal rings 54, 55, 56 from the lower face 59 of the cover member 32 are the same or substantially the same, with the difference L therebetween being 1 mm. In so doing, ample collapse margins for the flexible seal rings 54, 55, 56 are assured. By making this difference smaller, the effects of accumulated air at the corner sections 78 (FIG. 3(b)) on pretreatment may be reduced, and pretreatment may be carried out in an appropriate fashion.

The difference L is not limited to a value of 1 mm, and values of L=1.1 mm or L=1.2 mm are acceptable as well; values of L may differ, provided that only one seal ring among the plurality of seal rings 54, 55, 56 contacts the gasket face, ample collapse margins for the flexible seal rings 54, 55, 56 are assured, and the effects of accumulated air are minimal.

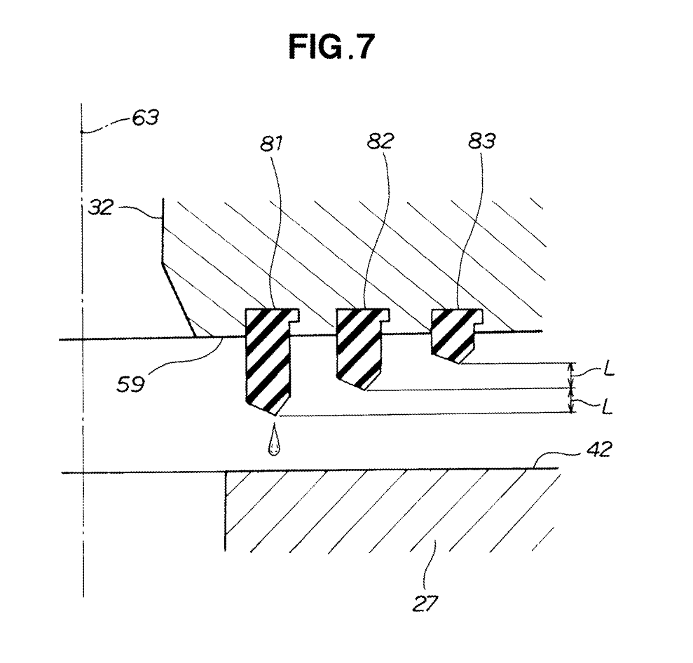

Next, FIG. 7 depicts a modified example of the seal rings shown in FIG. 6.

As shown in FIG. 7, the lower face 59 of the cover member 32 is a flat face. The cover member 32 is provided on the lower face 59 with a first seal ring 81 a second seal ring 82, and a third seal ring 83 which are flexible and adapted for intimate contact against the gasket face 42 to prevent leakage of treatment solution, and which are disposed in a concentric circle pattern centered on the center axis of the cylinder barrel. These first to third seal rings 81, 82, 83 are imparted with a height differential such that the levels of the lower edges of the sealing rings further away from the center axis 63 are progressively higher relative to that of the sealing ring closest to the center. This height differential (difference) L=1 mm.

The difference L is not limited to a value of 1 mm, and values of L=1.1 mm or L=1.2 mm are acceptable as well; values of L may differ, provided that only one seal ring among the plurality of seal rings 81, 82, 83 contacts the gasket face, ample collapse margins for the flexible seal rings 81, 82, 83 are assured, and the effects of accumulated air are minimal.

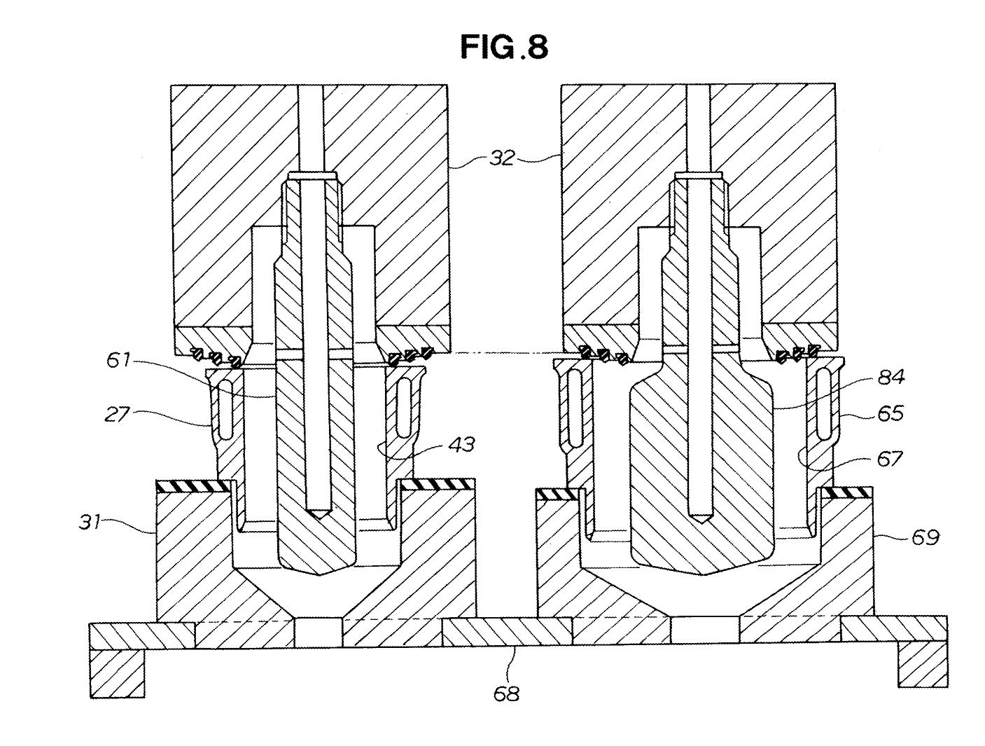

Next, different embodiment from the embodiment shown in FIG. 4 is discussed. In FIG. 8, portions of comparable configuration to those of FIG. 4 are assigned like reference symbols, and are not described in detail.

A small diameter nozzle 61 is disposed on the small diameter cylinder barrel 43 side. A large diameter nozzle 84 is disposed on the large diameter cylinder barrel 67 side. Despite the large size of the cylinder block 65, the volume of the space that is formed between the inner surface of the cylinder barrel 67 and the outside face of the nozzle 84 is small and the time needed to fill with the treatment solution is short, whereby the number of pretreatment steps can be reduced.

The description turns next to conditions in which cylinder blocks 27, 65 of different size are disposed.

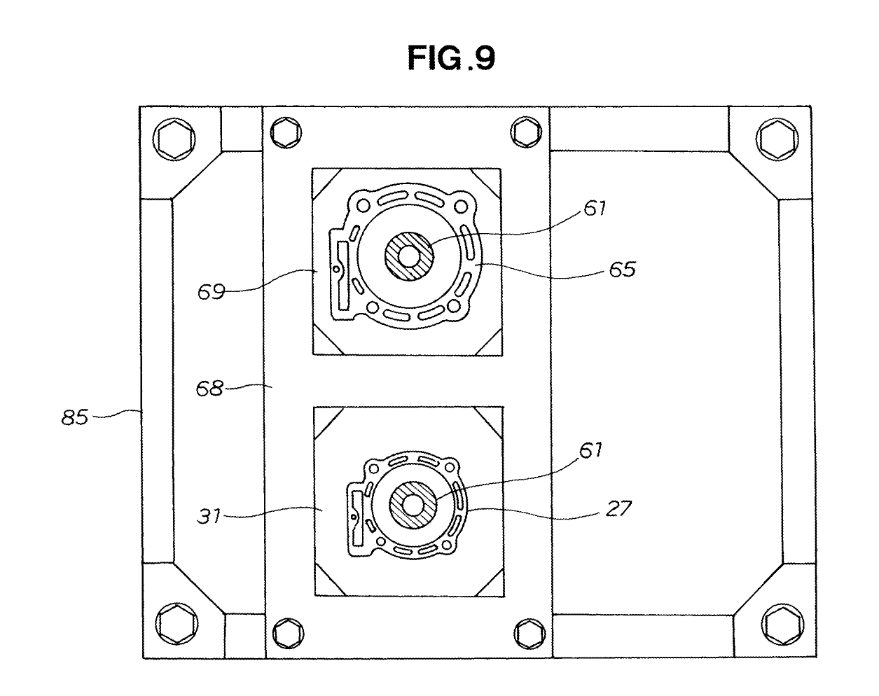

As shown in FIG. 9, a master pallet 68 is provided to a frame 85, and a first pallet 31 and a second pallet 69 are disposed on the master pallet 68. The first pallet 31 and the second pallet 69 can be freely combined and exchanged, whereby pretreatment can be carried out not only on cylinder blocks of the same type, but also on cylinder blocks of different types.

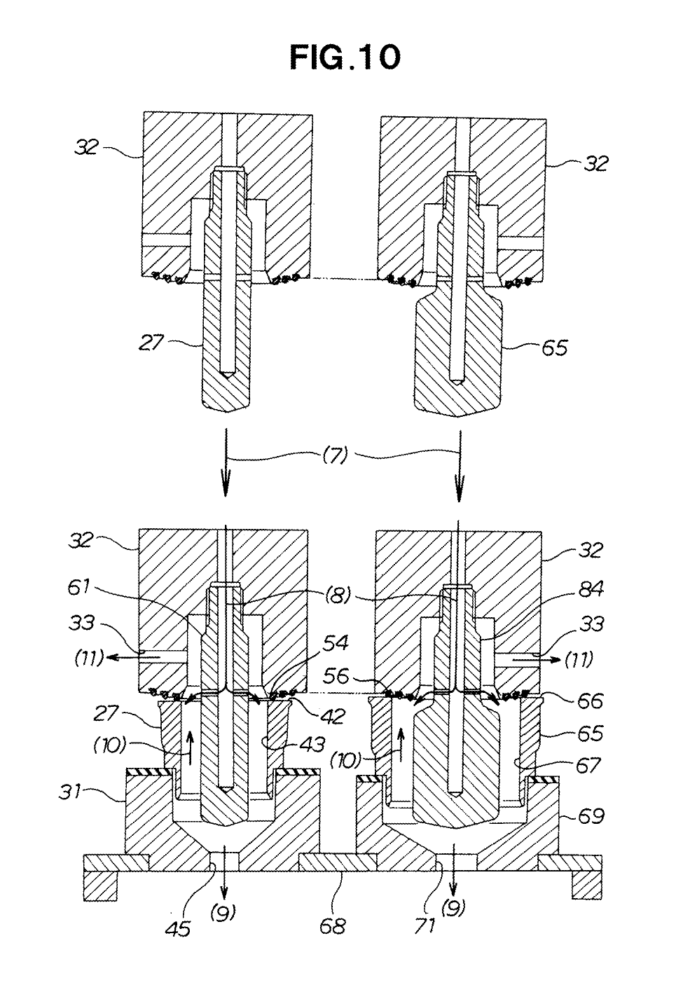

Operation of the cylinder barrel surface treatment device 10 discussed above is discussed in FIG. 10.

In FIG. 10, the cover members 32, 32 move as shown by arrows (7) to seal the gasket faces 42, 66.

The treatment solution from the nozzles 61, 84 is supplied to the inner surface of the cylinder barrels 43, 67 as shown by arrows (8). A portion of the treatment solution accumulated inside the cylinder barrels 43, 67 is discharged from the first drain channels 45, 71 as shown by arrows (9), (9). The supplied quantity of treatment solution exceeds the quantity discharged from the first drain channels 45, 71. Therefore, as shown by arrows (10), the treatment solution rises inside the cylinder barrels 43, 67. The remainder of the treatment solution accumulated inside the cylinder barrels 43, 67 is discharged from the second drain channels 33, 33 as shown by arrows (11).

In the embodiments, the cylinder barrel surface treatment device according to the present invention was implemented with three step sections, but there is no limitation to three, and provided that the gasket faces of the cylinder barrels can be sealed, two, four, or other plural number of step sections may be provided according to the type of cylinder barrel.

### INDUSTRIAL APPLICABILITY

The cylinder barrel surface treatment device of the present invention is particularly suitable for a pretreatment in plating of a cylinder barrel inner surface.

### REFERENCE SIGNS LIST

10: cylinder barrel surface treatment device
20: surface treatment section
27, 65: cylinder block
31: first pallet
32: cover member
33: second drain channel
42, 66: gasket face
43, 67: cylinder barrel
52: upper opening
54, 81: first seal ring
55, 82: second seal ring
56, 83: third seal ring
59: lower face
63: center of cylinder barrel
64: step section
68: master pallet
69: second pallet

1. A cylinder barrel surface treatment device for supplying a treatment solution into a cylinder barrel of a cylinder block of an internal combustion engine and treating an inner surface of the cylinder barrel, the device comprising:
a cylinder block supported on a pallet such that a gasket face is oriented upwardly; and
a cover member laid on the gasket face in such a manner as to cover an upper opening of the cylinder barrel,
wherein the cover member is provided at a lower face thereof with a plurality of sealing rings for making intimate contact with the gasket face so as to prevent leakage of the treatment solution, and the sealing rings have flexibility, are disposed concentrically centered on a center axis of the cylinder barrel, and are imparted with a height differential such that levels of lower edges of the sealing rings progressively increase in height further away from the center axis relative to the sealing ring closest to the center axis.

2. The cylinder barrel surface treatment device claim 1, wherein the lower face of the cover member is given a stepped shape such that the sealing rings project by substantially a same margin from the lower face.

3. The cylinder barrel surface treatment device of claim 1, wherein the pallet comprises a plurality of pallets for supporting each of the cylinder blocks being of different size.

4. The cylinder barrel surface treatment device for a cylinder barrel of claim 1, wherein the lower face of the cover member comprises a flat face, and the sealing rings is provided on a lower face of the flat face.
